(19) United States
(12) Patent Application Publication
(10) Pub. No.: US 2016/0022397 A1
(43) Pub. Date: Jan. 28, 2016

(54) SET OF DENTAL IMPLANTATION KITS

(71) Applicant: Sudimplant, Toulouse (FR)

(72) Inventor: Olivier BENHAMOU, Brussels (BE)

(21) Appl. No.: 14/802,019

(22) Filed: Jul. 17, 2015

(30) Foreign Application Priority Data
Jul. 25, 2014 (CH) 01149/14

(51) Int. Cl. A61C 19/02; A61C 13/08; A61C 13/00; A61C 8/00

(52) U.S. Cl. CPC A61C 19/02; A61C 8/0001; A61C 8/008; A61C 8/0089; A61C 8/0069; A61C 13/08; A61C 8/0053; A61C 8/0012; A61C 13/0003

(57) ABSTRACT

Set of implant kits comprising for each kit an implant pack comprising a dental implant, a cover screw and a healing screw provided for being screwed in the implant, a terminal drill provided for drilling in the jawbone at the place where the implant has to be implanted, and having a dimension compatible to the one of the implant, a screwing tool provided for being inserted into the implant and screw; and a prosthetic pack comprising a prosthetic abutment having an intra-implant part provided for being sealed or glued in the implant, and an extra-implant part provided for applying thereon a prosthesis, a castable abutment acting as a transfer coping, an analogous of the implant reproducing the implant at the laboratory; said set comprising a predetermined number of kits, to each kits there is each time allotted a diameter and a length respective of the implant selected among a predetermined number of combinations of implant diameters and lengths.

The present invention relates to a set of dental implantation kits comprising a predetermined number of dental implantation kits, each dental implantation kit comprising a dental implant and a transfer coping used for reproducing on a laboratory model a situation of the implant in the mouth after its application on a patient in order to realise a prosthetic abutment adapted to the dental arch of the patient.

Such a set is known from the international patent application WO 01/12098. This known set comprises for each kit a dental implant having a predetermined length and width in function of the type of tooth to be immediately replaced on the dental arch and transfer coping for the later manufacture of the prosthesis in a laboratory. Indeed, according to the teaching of this international patent application the jawbone is divided in six dental areas and an implant kit is allotted to each dental area.

The bone-integrated dental implants are supports provided for creating at the level of the jaw bone, resistant, effective, non-iatrogenic, long living, anchorages on which a fixed or removable dental prosthesis can be adapted in order to give the patient an adequate mouth function, a satisfactory comfort and again an aesthetic. The bone-integration is the direct anatomic, biological and functional connexion between a living and healthy bone and the surface of a dental implant supporting the dental prosthesis.

Implantation is a branch of dental surgery which consists in placing dental implants. The physicians specialised in maxillo facial surgery and stomatology, as well as dentist-surgeons having a specialised education in dental implantation, are the only ones authorised to practice this dental treatment.

A drawback of the known set is that on the one hand it comprises for each dental area a dental implant and a transfer coping, and on the other hand it imposes the dental specialist to buy on the market other surgical and prosthetic components for finalising the placing of the dental implant and the prosthesis. Generally the bio-shape of the implant, that is to say its length and its diameter, are essentially determined by the available bone volume of the concerned patient where the implant has to be placed and less by the tooth to be replaced. Moreover the fact of having in the set for each dental area a particular kit will leave the dental specialist with a large number of unused kits. In addition the known set does only foresees the kit where the tooth has been extracted, and not the kit where the patient has already lost his tooth.

Millions of patients throughout the world have been treated with bone-integrated dental implants, and their number grows with 10% per year. There exists more than 200 different dental implants systems on the market and the surgical and prosthetic kits have a large number of packs, that is to say specialised components and tools. The dental specialists have to face a large number of packs, the one even more specialised than the other. It thus becomes very difficult for a dental specialist to quickly and correctly select, at first sight and without errors, the packs for placing a dental implant and for choosing the prosthetic rehabilitation, which will be best for the patient according to an established dental treatment.

Moreover, the dental specialists using surgical and prosthetic kits comprising this large amount of packs, have to make huge investments for buying all this material and equipment in their dental practices. To these expenses other costs are added, as all this material, which has been exposed to ambient air while selecting the pack for that dental implant which corresponds to the treatment and during the placing of this implant, has to be thereafter sterilized. The sterilisation steps also presents the inconvenience of waiting time for reusing this material at a subsequent intervention, thereby limiting also the number of interventions, which the specialists can realise during their working day.

The object of the invention is to propose to practitioner a set of dental implant kits which enable in each kit to have brought together the necessary components for applying the implant at the place in the jawbone where the implant has to be placed, thereby taking into account essentially the bone volume available at this place. The object of the invention is thus to enable a choice of the implant to be placed independently of the missing or extracted tooth, and thus reduce the need of expensive and long specialisations and making practicians capable to place dental implants while reducing the need of large investments in material.

To this purpose a set of dental implantation kits according to the invention is characterised in that the dental implant is part of an implant pack and the transfer coping is part of a prosthetic pack, in each dental implantation kit:
said implant pack also comprising:
   a cover screw and a healing screw provided for being screwed on the dental implant;
   a terminal drill provided for drilling into the jawbone at a place where the dental implant has to be implanted, the terminal drill having a dimension compatible with the one of the dental implant; and
   a screwing tool provided for inserting in the dental implant and enabling in such a manner the placing of the dental implant in the jawbone;
said prosthetic pack also comprising:
   a castable abutment having an intra-implant part provided for reproducing the part foreseen to be inserted in the dental implant, and an extra-implant part provided for realising a prosthetic abutment having an angulation, a shape and a height adapted to said dental arch;
   a standardised prosthetic abutment for a fixed prosthesis or for a removable prosthesis and having an intra-implant part provided for being sealed or glued in the dental implant, and an extra-implant part provided for fixing thereon a dental prosthesis; and
   an analogous of the dental implant provided for receiving the intra-implant part of the castable abutment or the standardised prosthetic abutment;
      to each of said dental implantation kits there is each time allotted a respective diameter and a length of the dental implant, the standardised prosthetic abutment and the castable abutment being selected among a predetermined and limited number of combinations of dental implant length and diameters.

The set of predetermined kits selected according to combinations of implants lengths and diameters, reduces the number of packs proposed to the dentist or dental specialists. That is to say that the choice of the dentist or dental specialist is made easier and is guided, as it will be enough for him or her to select in a set of kits among the proposed packs, this one which suits with the bone volume of the patient and with the selected prosthetic solution. He or she will decide on the implant which suits to the treatment by measuring the diameter and the length of the existing bone located at the place where the implant has to be implanted, and of the fixed or removable prosthetic solution, according to the considered treatment plan. Ones both criteria have been determined, he or she is able to rapidly choose among the set of predetermined kits only this kit which is required, as they are grouped by diameter and length of the implant and by prosthetic solution. The kits comprised in the set bring together the necessary packs for responding to the needs of most of the clinical cases and according to the invention they are combined as implant packs and prosthetic packs.

The arrangement of the components and tools foreseen for the dental implantation in the implant packs and the prosthetic packs according to the invention, helps the dentist or the dental specialists to not making errors. An implant pack selected for a treatment is linked to a prosthetic pack. The dentist or dental specialist knows that in the implant pack he or she will find the elements relating to the dental implant which corresponds to the need of the patient (anatomy and volume of the bone), and that in the prosthetic pack, linked to the choice of the implant, he or she will find the elements which will enable to receive the prosthesis according to the established treatment plan. This helps the dentist or dental specialist so that there is no need to hesitate, nor that a wrong choice becomes possible, that is to say placing a dental implant and having prosthetic elements which do not correspond to the selected dental implant. This is a well-known error, as several months passes between the implant phase and the prosthesis phase in the dental implant treatment, during which the dentist or dental specialist sees a large number of patients, and when several persons work in the same team, which is not always easy to have the good classifying and storing practice.

All this causes that the dentist or dental specialist will be guided to make his choice of a dental implant within the proposed set of kits, thereby reducing the time of a such choice, and by reducing the possibility of making errors, as the number of packs is reduced. Thus, the implant pack with a determined implant length and diameter, associated with a prosthetic pack with a fixed or removable solution, enables to optimise the quantity of procedures the dentist or dental specialist has to realise during the working day, and reduces considerably the investment in material on the shelve necessary to these procedures and the causes for errors. Thus, he or she can order and buy only those implant kits having the diameter and the length needed for placing the implants and the prosthesis foreseen for his patient, so one implant kit per patient.

Consequently the dental implant treatments becomes feasible for a larger number of the population. The invention enables that the choice of packs is limited to a predetermined set of packs, which leads to an optimisation of the working time of the dentist or the dental specialist and avoids waist time and errors linked to the choice of the material.

The solution proposed by the international patent application WO 01/12098 leads the skilled person away from the one proposed by the present invention. Indeed, by starting with a concept where the jawbone is divided in dental areas, the prior art imposes to have a specific kit for each area, while according to the invention the dental specialist is able to choose for the implant or implants, only this kit or kits which fit with the bone volume available with his patient. As moreover the kit comprises all the components, the dental specialist is no longer obliged to look for the other components on the market, which not only makes his task easier, but also considerably reduces the error probability. Even if the components such as for example cover screw, the drill, the prosthetic abutment or the analogous of the dental implant are as such known from the prior art, the skilled person does not obtain a teaching from the international patent application WO 01/12098 to add those components to the kits known thereof. Adding those components to the kits known from the international patent application WO 01/12098 would have as a consequence that they would have even more components which would not be used, as they would be present for each dental area. The concept according to the present invention to group the dental implant and the prosthetic abutment according to their well-defined length and diameter is thus not taught by the prior art.

Preferably in the set of kits according to the invention the combinations of lengths and diameters of the dental implants and the abutments are selected among dental implants and prosthetic abutments presenting a predetermined range of lengths, in particular between 8 and 14 mm, and a predetermined ranges of dimensions of diameters, in particular between 3.3 and 4.7 mm. Those ranges enable to propose combinations of implant packs and prosthetic packs which correspond to most of the clinical cases (80% of the clinical cases), proposing a standardisation of the dental implants according to general cases present with a majority of the patients. The choice of the dimension enables that the number of kits in the set is reduced, thereby presenting the advantages of a time reduction in selecting the packs, cost reduction of the investments in material for a dental practice, and the reduction of error sources.

According to a preferred embodiment of a set of kits according to the invention, the number of predetermined dental implantation kits is equal to twenty four. This instead of several hundred, as it is the case with the prior art. Consequently the dentist or dental specialist reduces the investment in material for equipping his practice as the number of packs is considerably reduced. The proposed set of kits has for consequence that there is no longer a need to have a large stock of material in the dental practice. The kits present the combinations of implant packs and prosthetic packs which correspond to most of the treatments, that is to say that starting from two criteria, the dimension of the implant and the prosthetic solution, the dentist or dental specialist can respond to 80% of the clinical cases.

In particular, according to an embodiment of a set of kits according to the invention, a screwing tool is also provided for gripping as well in the cover screw as in the healing screw. Thus the screwing tool can also be used as screwdriver, this being complementary to the normal use of the screwing tool, which enables the dentist or dental specialist to manipulate the dental implant. The screwing tool thus enables him or her as well the taking as the placing of the dental implant in the maxillary bone, without having to manually touch the implant.

Preferably, in a set of kits according to the invention the implant pack comprises a clamping means, in particular a hexagonal key, enabling a manual placing of the dental implant during implantation in the jawbone. This clamping means used in a manual manner by the dentist or dental specialist enables to clamp the implant by using only one hand. The profile of the clamping means presents a profile which matches the one of the mechanical grip of the dental implant, in such a manner that the dentist or dental specialist can insert the implant therein and screw it in the bone. This clamping means can have the shape of a hexagonal key and enables that the implant pack comprises all the components and tools necessary for placing the dental implant. This is particularly suitable in situations in which the dentist or the dental specialist is faced with less favourable conditions, for example when he or she has to do his work in a temporary premise, or when there is no electricity, as it could be the case in a remote village. Thus the invention can really generalise the implantation practice and provide it available to less fortunate people.

Preferably in the set of kits according to the invention the extra-implant part of the prosthetic abutment is configured under a shape of an attachment member provided for applying directly thereon a dental prosthesis. This extra-implant part may present the form of an abutment provided for directly receiving a dental prosthesis and enabling that the dental prosthesis is well fixed and thus stable.

Advantageously in the set of kits according to the invention the prosthetic abutment of the prosthetic pack called “fixed” is a conical prosthetic abutment enabling to fix a crown or a bridge.

Advantageously in the set of kits according to the invention the prosthetic abutment of the prosthetic pack called “removable” is a spherical prosthetic abutment enabling to stabilize a denture.

The choice among the prosthetic solutions, a conical prosthetic abutment or a spherical prosthetic abutment, enables the dentist or the dental specialist to better target the treatment for responding the need of the patient.

In particular, according to an embodiment of a set of kits according to the invention, each implant pack is disposable and sterilised, and each prosthetic pack is disposable. The dentist or dental specialist uses the components furnished in the kit selected according to the clinical case, once the implant is implanted the implant pack is thrown away, as well as once the prosthesis is in place the prosthetic pack is thrown away. This avoids the need to sterilise and to store packs, thus avoiding the wear of the components and guarantees that the quality of the components is above all criticism.

Moreover, in a preferred embodiment according to the invention, the prosthetic abutment of the prosthetic pack is a prosthetic abutment in titanium. This abutment is preferably sealed or glued in the dental implant. In particular, the sealing is a usual practice for dentists with a general education. Thus the practice of dental implant based on sealing of the prosthetic abutment also becomes a usual practice. Thus the dental implantation, which is considered as a technique which needs a particular skill, can become a basis technique of known procedures for general dentists. Today titanium is commonly used for the manufacture of prosthetic abutments, as it is a well-accepted material by the human body.

In particular, according to an embodiment of the set of kits according to the invention, the extra implant part of the castable abutment is formed by two flattened cubes linked to each other by a cylinder. This is particularly useful when the abutment is used as a transfer copy.

The invention will now be described in more details with reference to the drawings showing a preferred embodiment of a set of kits. In the drawings:

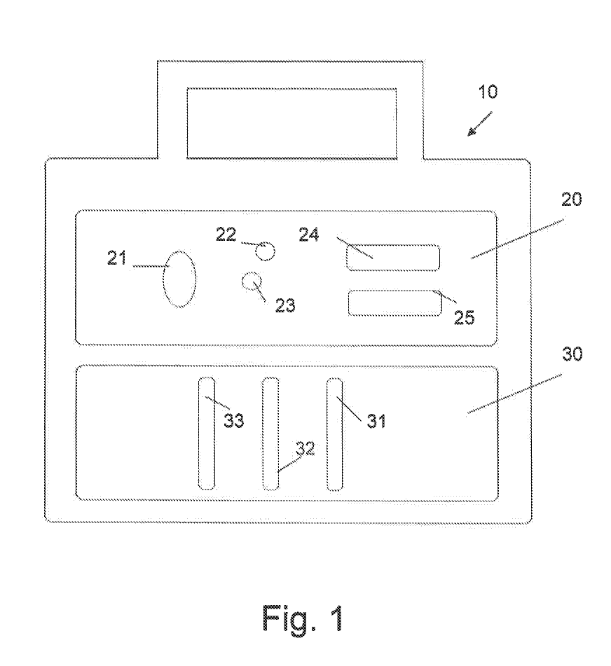

FIG. 1 shows a dental implant kit according to the invention comprising an implant pack and a prosthetic pack; and

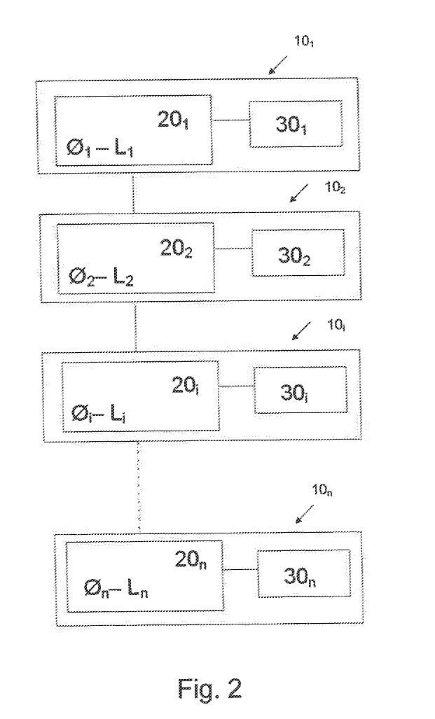

FIG. 2 shows a scheme for illustrating that to each dental implant kit there is each time allotted a respective diameter and a length for the implant, the implant pack, and a prosthetic solution, fixed or removable, the prosthetic pack.

In the drawings a same reference sign is allotted to a same or analogous element.

In the following description by practitioner it will be understood the dentist or the dental specialist or another person who realises dental implant procedures by using the set of dental implant kits according to the invention. By pack it will be understood as well the implant pack 20 as the prosthetic pack 30, which are combined in a dental implant kit 10.

FIG. 1 illustrates in a schematic manner one of the dental implant kits 10 which are part of a set of kits according to the invention. So FIG. 1 illustrates an implant pack 20 having a dental implant with a determined diameter and a determined length, and a prosthetic pack 30 having a fixed or removable prosthetic solution, of which the dimension is compatible with the one of the dental implant present in the implant pack 20.

A dental implant 21 is provided to be placed in the maxillary bone, and can be totally or partially buried in the bone of a patient which is partially or totally without teeth, in order to obtain a prosthetic reinstatement when there has been a unitary loss of a tooth, an intermediate tooth loss, a terminal tooth loss, a total teeth loss, or for the stabilisation of a removable prosthesis (denture).

Each implant pack 20 comprises a dental implant 21 presenting each time a well-defined diameter (Ø) and length (L). The implant pack 20 also comprises a cover screw 22 and a healing screw 23, which have such a dimension that they can be screwed in the dental implant 21. A terminal drill 24, which enables to drill into the jawbone at the place where the dental implant 21 has to be implanted, is also part of the pack. The drill 24 has a dimension which is compatible with the one of the dental implant 21. The pack also comprises a screwing tool 25, which not only can be introduced into the dental implant 21 in order that the practitioner can manipulate it, but preferably also serves for screwing the screws 22 and 23 on the dental implant. This pack can also comprise a clamping means 26, for example a hexagonal key, enabling to manually put in place the dental implant 21.

The prosthetic pack 30 comprises a standardised prosthetic abutment 31 presenting an intra-implant part provided for being fixed, preferably by sealing or gluing, into the dental implant 21, and an extra-implant part on which the dental prosthesis will be fixed. This prosthetic abutment 31 can be conically and provided for receiving a fixed prosthesis, or it can be spherical and provided for receiving a removable prosthesis (denture). By a standardised prosthetic abutment 31 it is meant a prosthetic abutment provided for being essentially placed in the axis of the implant.

In the prosthesis pack 30, the intra-implant part of the prosthetic abutment 31, be it for a fixed or removable prosthesis, is adapted to the length and the diameter of the dental implant 21 to which they are associated. Moreover, in the prosthetic pack 30 presenting a conical prosthetic abutment 31 for a fixed prosthetic solution, the extra-implant part of the prosthetic abutment 31 is adapted to the diameter of the dental implant 21 to which it is associated.

A castable abutment 32 is also part of the prosthetic pack 30. The castable abutment has an intra-implant part provided for reproducing the part foreseen to be inserted in the dental implant 21 where the analogous 33 of the dental implant to which it is associated, and an extra-implant part. The extra-implant part of this castable abutment 32 is provided for realising a prosthetic abutment having an angulation, a shape and a height adapted to the dental arch of the patient. The extra-implant part of the castable abutment preferably comprises a transfer coping member, which is for example formed by two flattened cubes linked together by a cylinder. This causes this castable abutment 32 to be a component serving as well as a transfer coping for reproducing at a later stage the exact implant situation in the mouth at the prosthesis laboratory, and also serves to realise a personalised abutment casted in metal and adapted to the dental arch of the patient. The prosthetic pack 30 also comprises the analogous of the dental implant 33 provided for receiving the intra-implant part of the castable abutment 32. This analogous 33 is provided for reproducing the exact position of the implant on a laboratory model, thus receiving the castable abutment 32 for manufacturing the personalised abutment, which will be sealed in the dental implant 21.

FIG. 2 shows a scheme for illustrating how on each of the dental implantation kits 10 there is each time allotted a respective diameter (Ø) and length (L) of a dental implant 21, determining the combination of the implant pack 20 and the prosthetic pack 30. The combination of this diameter (Ø) and this length (L) is selected among ranges of diameters (Ø) and lengths (L) which correspond to most of the clinical cases as mentioned before.

The dimensions of the lengths (L) for the implant packs 20 are selected among a predetermined range of dimensions lengths (L), in particular a range between 8 and 14 mm. Thus, the most commonly used lengths are 8, 10, 12 and 14 mm. To this implant lengths (L) there are allotted diameters (Ø) present in a predetermined range of dimensions of diameters (Ø), in particular between 3.3 and 4.7 mm. For example a pack 20 comprising a dental implant 21 having a length of 8 mm and a diameter of 3.3 mm, or a dental implant 21 having a length of 8 mm and a diameter of 4.7 mm.

The set of prosthetic packs 30 comprises packs having fixed solutions, for example for placing a crown or a bridge, and packs having removable solutions, for example for stabilising a denture. According to a preferred embodiment of the invention, the prosthetic pack 30 belonging to the fixed solutions comprises a prosthetic abutment 31 of conical shape manufactured in titanium, the latter being a well-known abutment. It has to be noted that developments in material could lead to other materials for the manufacture of prosthetic abutments 31.

When the implant 21, once placed, presents an emergence angle which is not compatible with a standardised prosthetic realisation, use will be made of an angled personalised abutment. In this case, the castable abutment 32 is used and shaped in the laboratory for obtaining an angulation which is compatible with a prosthetic solution or rehabilitation adapted to the dental arch of the patient.

The analogous of the dental implant 33 enables to reproduce on a plaster model in the laboratory the position of the dental implant 21 implanted in the bone, thanks to the use of the castable abutment 32 which acts as a transfer coping. In such a manner, the prosthetic laboratory can manufacture a crown or a bridge starting from the model of the mouth obtained by having the castable abutment 32 and by introducing it in the dental implant 21 while following the shape of the desired prosthetic solution or rehabilitation.

For determining the kit suitable for the patient starting from a scanning of the jawbone at the place where the dental implant 21 has to be implanted, the practitioner will evaluate the available dental bone volume at the place where the dental implant has to be applied. Thus, while using this dental bone volume evaluation, he or she will determine which is the combination of diameter (Ø) and length (L) of the dental implant 21 to be implanted. With this evaluation, and according to the desired prosthetic solution, fixed or removable, he or she will choose among the proposed options within the set of kits, the one which corresponds to the dental implant 21 which has to be implanted. Once he or she knows this combination, which corresponds to the dental implant 21 needed, he or she can order and buy the single use kit 10 comprising only the implant pack 20 and the prosthetic pack 30 having the diameter and the length selected and enabling to treat the patient. Within this kit 10 he or she will find all the components necessary for his or her patient. After use of the kit 10 the practitioner will throw away the remaining of the material which has been exposed and which has not been implanted in the patient's mouth.

This signifies that once the practitioner has determined the combination of the diameter (Ø) and length (L) of the dental implant 21 needed, starting from the evaluation of the dental bone volume obtained by the scanning, he or she also has chosen the prosthetic abutment 31, conical or spherical, which he will use for the selected dental implant 21. This signifies that the dimensions of the dental implant 21 which has been determined as appropriate for the treated case, will correspond to a predefined length of the intra-implant part of the prosthetic abutment 31 which is present in the prosthetic pack 30 linked to the implant pack 20. Thus, each implant pack 20 is linked to a prosthetic pack 30 which corresponds for each patient.

Thus, the set of kits is limited to a predetermined number of kits 10 comprising implant packs 20 and prosthetic packs 30 presenting the combinations of predetermined diameters (Ø) and lengths (L). In FIG. 2 the set of dental implant kits is shown by means of n kits 10₁, 10₂, 10ᵢ and 10ₙ. A first kit 10₁ combines a first dental implant pack 20₁ and a first prosthetic pack 30₁ for a combination of a first diameter Ø₁ and a first length L₁ of a dental implant 21 in the implant pack 20₁, and corresponds to a selection among a fixed prosthetic solution or a removable prosthetic solution for the prosthetic pack 30₁.

A second kit 10₂ combines a second implant pack 20₂ and a second prosthetic pack 30₂. This combination corresponds to the combination of a second diameter Ø₂ and a second length L₂ of a dental implant 21 in the implant pack 20₂, and corresponds to a selection among a fixed prosthetic solution or a removable prosthetic solution for the prosthetic pack 30₂. And so on until the kit 10ₙ combining an implant pack 20ₙ and a prosthetic pack 30ₙ. This combination corresponds to the combination of a diameter Øₙ and a length Lₙ of a dental implant 21 in an implant pack 20ₙ, and corresponds to a selection among a fixed prosthetic solution or a removable prosthetic solution for the prosthetic pack 30ₙ.

According to a preferred embodiment of the invention, the implant packs and the prosthetic packs are combined for forming a set of twenty four predetermined kits in order to offer the practitioner the necessary kits for realising dental implants procedures responding to at least 80% of the clinical cases. The possible combinations are between twelve implant packs 20 corresponding to predetermined ranges of diameters (Ø), in particular between 3.3 and 4.7 mm, and lengths (L), in particular between 8 and 14 mm, and two prosthetic packs 30 corresponding to fixed or removable prosthetic solutions. The twelve implant packs 20 are formed by the combinations of dimensions and diameter and the following length; Ø=3.3 mm and L=8, 10, 12 or 14 mm, Ø=3.9 mm and L=8, 10, 12 or 14 mm, Ø=4.7 mm and L=8, 10, 12 or 14 mm. That is to say, that the set of 24 kits is obtained by the combination of twelve implant packs 20 multiplied by two prosthetic packs 30.

The invention proposes this disposable kits 10, thus the practitioners do no longer need chirurgical and prosthetic kits with multiple components to be cleaned and sterilised at the first use and sterilised again for later uses, this avoids asepsis, traceability, wear problems caused by multiple interventions. By using the kits 10 the practitioner optimises the number of procedures to be realised in one working day having at his disposal all the necessary material therefor.

The protocol followed by the practitioner for realising the dental implantation procedure which enables him to place a dental implant 21 by using the set of dental implant kits according to the invention, generally consists in three steps: the chirurgical application of the dental implant 21, the bone and soft tissue healing, and the start-up of the dental implant 21 function.

The surgical application of the dental implant 21 comprises the rotational instrumental sequence by using the terminal drill 24 for drilling in the bone. Once the bone has been prepared for receiving the dental implant 21, the practitioner will pick-up the dental implant 21 by means of the screwing tool 25 present in the implant pack 20 which he or she has chosen according to the measured diameter (Ø) and length (L), and he screws it in the bone at the place where he drilled. He can also use the hexagonal key present in the implant pack 20 for a manual placing of the dental implant 21. Thereafter, by using the screwing tool 25, the practitioner will pick-up the cover screw 22 or the healing screw 23, which are also comprised in the implant pack 20 and close the dental implant 21.

After the time necessary for the bone healing in order to obtain bone-integration which varies between 3 and 6 months, the dental implant 21 presents a clinical fixing enabling to apply the prosthetic phase. For starting-up the dental implant function, preferably, the prosthetic abutment 31 is sealed or glued in the dental implant 21. Thereafter, a footprint of the prosthetic abutment is taken, or in case of a personalised abutment the footprint of the castable abutment 32, to enable a technician in the laboratory to build the crown, bridge, or denture, according to the treatment.

1. A set of dental implantation kits comprising a predetermined number of dental implantation kits, each dental implantation kit comprising a dental implant and a transfer coping used for reproducing on a laboratory model a situation in a mouth of the implant after its application on a patient in order to realise a prosthetic abutment adapted to the dental arch of the patient, characterised in that the dental implant is part of an implant pack and the transfer coping is part of a prosthetic pack, in each dental implantation kit:
said implant pack also comprising:
a cover screw and a healing screw provided for being screwed on the dental implant;
a terminal drill provided for drilling into the jawbone at a place where the dental implant has to be implanted, the terminal drill having a dimension compatible with the one of the dental implant; and
a screwing tool provided for inserting in the dental implant and enabling in such a manner the placing of the dental implant in the jawbone;
said prosthetic pack also comprising:
a castable abutment having an intra-implant part provided for reproducing the part foreseen to be inserted in the dental implant, and an extra-implant part provided for realising a prosthetic abutment having an angulation, a shape and a height adapted to said dental arch;
a standardised prosthetic abutment for a fixed prosthesis or for a removable prosthesis and having an intra-implant part provided for being sealed or glued in the dental implant, and an extra-implant part provided for fixing thereon a dental prosthesis; and
an analogous of the dental implant provided for receiving the intra-implant part of the castable abutment or the standardised prosthetic abutment;
to each of said dental implantation kits there is each time allotted a respective diameter and a length of the dental implant, the standardised prosthetic abutment and the castable abutment being selected among a predetermined and limited number of combinations of dental implant length and diameters.

2. The set of dental implantation kits according to claim 1, wherein the combinations of lengths and diameters of the dental implants are selected among dental implants presenting a predetermined range of lengths, in particular between 8 and 14 mm, and a predetermined ranges of dimensions of diameters, in particular between 3.3 and 4.7 mm.

3. The set of dental implantation kits according to claim 1, wherein the number of predetermined dental implantation kits is equal to twenty four.

4. The set of dental implantation kits according to claim 1, wherein the screwing tool is also provided for gripping as well in the cover screw as in the healing screw.

5. The set of dental implantation kits according to claim 1, wherein the implant pack comprises a clamping means, in particular a hexagonal key, enabling a manual clamping of the dental implant during implantation in the bone.

6. The set of dental implantation kits according to claim 1, wherein the extra-implant part of the prosthetic abutment is configured as an attachment member provided for applying directly thereon a dental prosthesis.

7. The set of dental implantation kits according to claim 1, wherein the prosthetic abutment of the prosthetic pack is a conical abutment enabling the fixation of a crown or a bridge.

8. The set of dental implantation kits according to claim 1, wherein the prosthetic abutment of the prosthetic pack is a spherical prosthetic abutment enabling the stabilization of a denture.

9. The set of dental implantation kits according to claim 1, wherein each implant pack is disposable and sterilised, and each prosthetic pack is disposable.

10. The set of dental implantation kits according to claim 1, wherein the extra implant part of the castable abutment is formed by two flattened cubes linked to each other by a cylinder.

11. The set of dental implantation kits according to claim 1, wherein the castable abutment serves once casted to the manufacturing of a personalised abutment adapted to the patient's dental arch.

12. The set of dental implantation kits according to claim 1, wherein the prosthetic abutment of the prosthetic pack is a prosthetic abutment in titanium.
